(19) United States
(12) Patent Application Publication
(10) Pub. No.: US 2002/0031956 A1
(43) Pub. Date: Mar. 14, 2002

(54) Connecting clip and battery replacement cable

(75) Inventor: Yoshiaki Nakatsuka, Osaka (JP)

Correspondence Address: KODA & ANDROLIA, Suite 3850, 2029 Century Park East, Los Angeles, CA, 90067-3024, US

(73) Assignee: SEIWA INDUSTRY CO., LTD.

(21) Appl. No.: 09/841,352

(22) Filed: Apr. 24, 2001

(30) Foreign Application Priority Data
Sep. 13, 2000 (JP) 2000-277677

(51) Int. Cl. H01R 11/00

(52) U.S. Cl. 439/835

(57) ABSTRACT

A battery replacement cable comprising: a cable element; clips connected to one end of the cable element, the clips including clamping sections having a thickness that allows the clamping section to clamp a terminal of a new battery and further allows a cable terminal of an electrical system of a vehicle to be connected to the terminal so that the clamping section and the cable terminal are both on the battery terminal; and a connecting plug attached to another end of the cable element and plugged into a cigarette lighter receptacle of the vehicle. The cable powers the electric devices of the vehicle without any power interruption during vehicle battery replacement.

### BACKGROUND OF THE INVENTION

1. Field of the Invention

The present invention relates to a connecting clip to be mounted on the battery terminal of, for instance, an automobile battery and further to a battery replacement cable to which the connecting clip is attached.

2. Prior Art

When a battery of, for instance, an automobile is replaced, battery cables connected to the battery is removed from the battery terminal. When the battery cables are thus removed, the electrical system of the automobile is cut off until the new battery is properly installed. As a result, the data inputted in the electrical devices such as the radio, clock, audio system and car navigation system is erased; and such data need to be re-inputted each time the battery is replaced.

So as to prevent data loss during the battery replacement, an auxiliary battery is occasionally used. An auxiliary battery is connected to the electrical devices via, for instance, the cigarette lighter receptacle that is an accessory of the automobile, so that electricity is supplied to the electric devices. The old battery is replaced by the new battery while the auxiliary battery is thus being connected.

However, when the electricity is supplied with an auxiliary battery during battery replacement, there are a total of three batteries (the new battery, the old battery, and the auxiliary battery) in the vicinity. In view of this inconvenience, there is a demand for a means that can supply electricity to the electrical devices without using an auxiliary battery.

### BRIEF SUMMARY OF THE INVENTION

The present invention is to solve the above problems.

It is, therefore, an object of the present invention to provide a battery replacement cable which is used to supply electric power to electrical devices of, for instance, an automobile from a I new battery during battery replacement.

It is a further object of the present invention to provide a connecting clip that is attached to the battery replacement cable and mounted on the battery terminal of a new battery.

In the present invention, the connecting clip that includes a clamping section for clamping the terminal of a new battery is attached to one end of the battery replacement cable, and the battery replacement cable is connected to the new battery by way of clamping, with the clamping sections, the terminal of the new battery from the side. In other words, in the present invention, with the battery replacement cable being connected to the terminal of the new battery, the cable terminal of the electrical system of the automobile is connected also to the same battery terminal of the new battery.

The battery replacement cable is, at its another end, provided with a connection plug. Upon battery replacement, the clamping section at one end of the battery replacement cable is connected to the battery terminal of the new battery and the connection plug at another end of the cable is connected to or plugged into the cigarette lighter receptacle of the automobile. As a result, the electrical devices of the automobile is kept in connection with the new battery and supplied with electricity from the new battery via the battery replacement cable. Thus, with keeping this connection, the cable terminal of the electrical system of the automobile is switched from the old battery to the new battery while the electricity is constantly supplied to the electrical devices from the new battery via the battery replacement cable, thus avoiding the data loss.

In the meantime, the battery terminals of a battery have a specific length. As a result, if the thickness of the clamping sections of the connecting clip of the battery replacement cable is large, the connecting clip of the battery replacement cable and the cable terminal of the electrical system are not mounted on the same battery terminal due to its limited length.

Accordingly, the clamping section of the connecting clip of the battery replacement cable is preferable to be as thin as possible. In the present invention, the clamping section is designed so as to have the thickness that allows the clamping section and the cable terminal of the automobile electrical system to be both mounted on the same electrode terminal of the new battery one on the other.

The connecting clip, that is of a scissors type, is comprised of a pair of flat metal elements and includes a gripping section and the above-described clamping section. The gripping section is formed by bending the root portions of the pair of the flat metal elements into a U shape or into a cylinder. The clamping section is the tip end of this flat metal elements with no bending applied. In other words, the thickness of the flat metal elements is the thickness of the clamping section of the clip. Thus, the thickness of the clamping section can be sufficiently small. Furthermore, a stopper means can be formed in the clip so as to prevent the overlapping of the tip ends of the metal elements, which form the clamping section, when the clamping section is closed. With the stopper means provided, the distance in which the clamping section is moved when the clamping section is opened so as to clamp the battery terminal of the new battery can be reduced.

### BRIEF DESCRIPTION OF THE SEVERAL VIEWS OF THE DRAWINGS

FIG. 1A is a front view of the connecting clip for the battery replacement cable according to the present invention,

FIG. 1B being a top view thereof,

FIG. 2 is a sectional view of the connecting clip taken along the lines 2-2 in FIG. 1A;

FIG. 3 is a side view of the battery terminal of a (new) battery to which the connecting clip and the automobile cable terminal are both mounted; and

FIG. 4 is a perspective view of the battery replacement cable connected to a battery.

### DETAILED DESCRIPTION OF THE INVENTION

Below, an embodiment of the battery replacement cable of the present invention will be described with reference to the accompanying drawings.

As best seen from FIG. 5, the battery replacement cable 5 of the present invention is equipped with, at its one end, two connecting clips 3a and 3b that are to be connected to electrode or battery terminals 2a and 2b of a battery 1, and a connection plug 4 that is to be connected to a cigarette lighter receptacle of, for instance, an automobile (not shown) is attached at its another end. The clips 3a and 3b and the lighter plug 4 are connected at the ends of cables 5a and 5b.

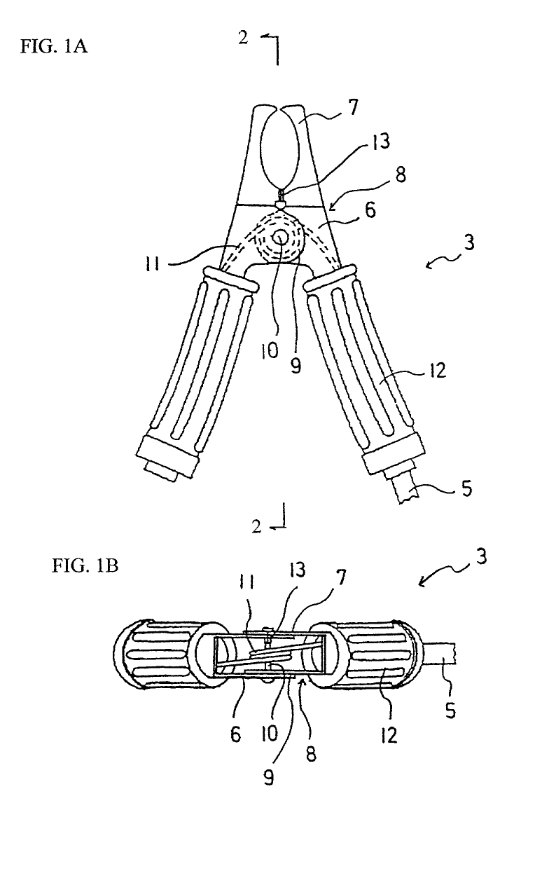

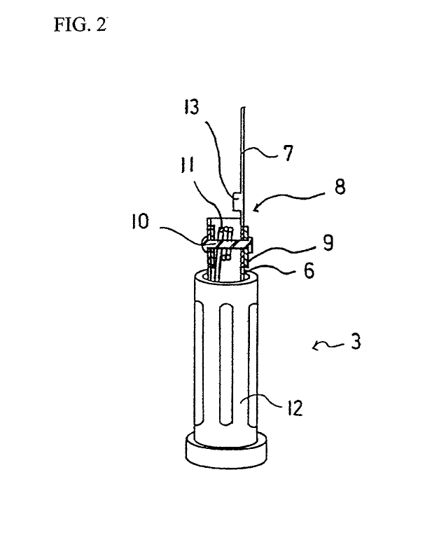

Since the connecting clips 3a and 3b are the same in structure, the following description will be made for one of them using the reference numeral “3”. As seen from FIG. 1, the connecting clip 3 is formed by joining together a pair of thin, flat metal elements 8. Each of the metal elements 8 has a gripping section 6 and a clamping section 7. The gripping section 6 is formed by bending the root portion of the metal element 8 into a U shape or into a cylinder, and the clamping section 7 is formed by leaving the tip end portion of the metal element flat “as is” without bending. The thus formed metal elements 8 are hingedly assembled together so as to pivot relative to each other like scissors. These metal elements 8 are formed by a bending method or a pressing method.

The open sides of the U shaped or cylindrical gripping sections 6 of the metal elements 8 are brought to face each other, and joining areas 9 formed in the gripping sections 6 so as to protrude inward on the front and back surface sides of the tip ends of the gripping sections 6 are overlapped with each other and joined via a pivoting shaft 10. A coil spring 11 is disposed around this pivoting shaft 10 so as to drive the tip ends of the metal elements that form the clamping section 7 in the closing direction.

The base ends of the gripping sections 6 are covered by sleeve tubes 12. The sleeve tubes 12 are made of an insulating resin, so that the user does not receive electrical shocks when the connecting clip 3 is connected to the terminal 2 of the battery 1. The sleeve tubes 12a of the connecting clip 3a that is connected to the anode terminal 2a of the battery 1 is red, and the sleeve tubes 12b of the connecting clip 3b that is connected to the cathode terminal 2b of the battery is black. This is for ensuring that the connecting clips 3a and 3b will not be connected to wrong terminals. The cable 5 (5a and 5b) is inserted into one of the sleeve tubes 12 of each one of the connecting clips 3 (3a and 3b) and connected to the gripping section 6 of each connecting clip 3.

The clamping sections 7 of each connecting clip 3 are formed in the same plane as the back surface of the gripping sections 6 so that the clamping sections 7 open and close in the direction perpendicular to the direction of the thickness when the metal elements 8 are pivoted. Thus, the clamping sections 7 (comprising a pair of the metal elements) can clamp and be connected to the terminal 2 of the battery 1. The inner edges of the base ends of the clamping section 7 (or of the pair of the metal elements) are bent toward the front surface side, thus forming stopper edges 13. The stopper edges 13 prevent the overlapping of the tip ends of the metal elements 8 when the clamping sections 7 are closed by the spring force of the coil spring 11.

The outer edges of the clamping sections 7 form a continuous curve with the outer edge of the rear surface of the gripping sections 6. The inner edges of the clamping sections 7 are shaped so as to form a substantially elliptical space as best seen from FIG. 1 when the clamping sections 7 are closed and the stopper edges 13 of the metal elements 8 come into contact. With this structure, the amount of movement of the tip ends of the pair of metal elements 8 that is necessary to open the clamping sections 7 and clamp the electrode terminal 2 is reduced.

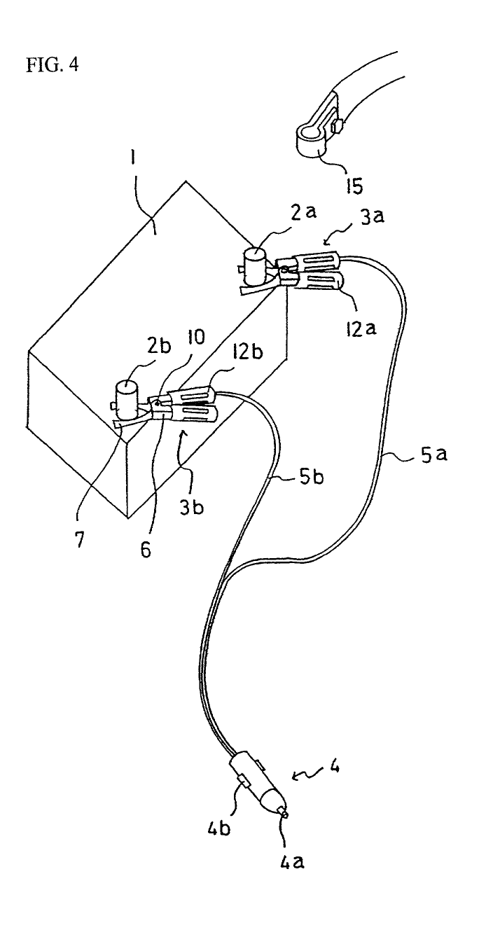

As seen from FIG. 4, the connection plug 4 at the end of the cable 5 has an anode terminal 4a, and a cathode terminal 4b is formed on the side surface of the connection plug 4. The connection plug 4 is connected to the electrical devices (not shown) of an automobile when it is inserted into the cigarette lighter receptacle (not shown) of the automobile. The cable 5a that connects the connection plug 4 to the connecting clip 3a that is to be connected to the anode terminal 2a of the battery 1 is covered by a red insulating resin. The cable 5b that connects the connection plug 4 to the connecting clip 3b that is to be connected to the cathode terminal 2b of the battery 1 is covered by a black insulating resin.

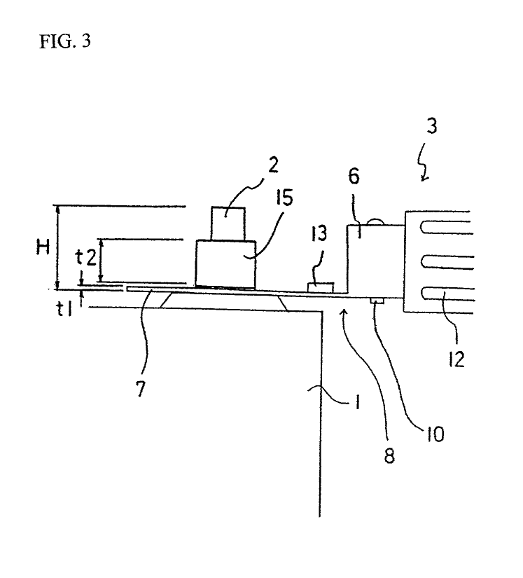

With the structure above, as seen from FIG. 3, the connecting clip 3 is connected to the (new) battery 1 by clamping the root portion of the battery terminal 2 with the clamping section 7; then the cable terminal 15 of the electrical system of the automobile is connected to the upper portion of the electrode terminal 2 so that the cable terminal 15 is above the clamping section 7 close to each other. As seen from FIG. 3, the clamping section 7 of the clip 3 is designed so that the sum of the thickness tl of the clamping section 7 of the clip 3 and the thickness t2 of the cable terminal 15 is smaller than the length or height H of the terminal 2 of the battery 1.

In use, the red connecting clip 3a and black connecting clip 3b are first respectively connected to the root portion of the anode terminal 2a and the root portion of the cathode terminal 2b of the new battery 1. The connection plug 4 at the end of the cable 5 (5a and 5b) is plugged into the cigarette lighter receptacle of the automobile. Thus, the electricity is supplied to the electrical devices of the automobile from the new battery 1 via the battery replacement cable 5.

While the electricity is supplied to the electrical devices from the new battery 1 via the battery replacement cable 5 thus avoiding the data loss of the electrical devices, the cable terminals 15 (only one shown) of the automobile are disconnected from the old battery (not shown) and the old battery is removed from the automobile. The cable terminals 15 are respectively appropriately connected to the anode terminal 2a and cathode terminal 2b of the new battery 1 that is installed in the automobile. Then, the connecting clips 3a and 3b that have been connected to the new battery 1 are removed, first from the anode terminal and then from the cathode terminal; and the connection plug 4 is unplugged form the cigarette lighter receptacle. The battery replacement is thus completed.

The present invention is not limited to the embodiments described above, and various alterations are made within the scope of the present invention. For example, in the above embodiment, the connecting clips are connected to the battery replacement cable; however, they can be connected to booster cables that are used for supplying electricity from another battery to jump-start the engine when the charge of the original battery is exhausted. In addition, the connecting clips of the present invention are ideal for use in a limited space near the battery terminals of a battery as in the case where the terminals are disposed on the side (and not on the top) of the battery since the clamping section of the connecting clips are formed thin.

As is clear from the above description, the present invention makes it possible to supply electricity to the electrical devices of an automobile without using auxiliary batteries. As a result, there is no loss of data from audio, radio, car navigation systems, etc., since the power supply is not cut off during battery replacement.

1. A connecting clip attached to one end of a cable and has a clamping section that clamps a battery terminal of a battery, wherein said clamping section has a thickness that allows said clamping section to clamp said battery terminal and further allows a cable terminal of an electrical system of a vehicle to be connected to said battery terminal so that both said clamping section and said cable terminal are mounted on said battery terminal.

2. The connecting clip according to claim 1, wherein said clip is comprised of a pair of metal plates pivotally connected to each other and has a gripping section and said clamping section, said gripping portion being formed by bending one end of said metal plates into a U shape, and said clamping section being at another ends of said metal plates and formed flat.

3. The connecting clip according to claim 2, wherein said clip is provided with a stopper section that prevents said flat ends of said metal plates that form said clamping section from overlapping with each other when said clamping section is closed.

4. A battery replacement cable comprising:
a cable element;
a clip connected to one end of said cable element, said clip including a clamping section that has a thickness that allows said clamping section to clamp a battery terminal of a battery and further allows a cable terminal of an electrical system of a vehicle to be connected to said battery terminal so that both said clamping section and said cable terminal are mounted on said battery terminal; and
a connection plug connected to another end of said cable element so as to be plugged into a cigarette lighter receptacle of said vehicle,
wherein said cable is used with said clamping sections mounted on said battery terminal of a new battery during battery replacement.

5. The battery replacement cable according to claim 4, wherein said clip is comprised of a pair of metal plates pivotally connected to each other and has a gripping section and said clamping section, said gripping portion being formed by bending one end of said metal plates into a U shape, and said clamping section being at another ends of said metal plates and formed flat.

6. The battery replacement cable according to claim 5, wherein said clip is provided with a stopper section that prevents said flat ends of said metal plates that form said clamping section from overlapping with each other when said clamping section is closed.
